(19) United States
(12) Patent Application Publication
(10) Pub. No.: US 2022/0338490 A1
(43) Pub. Date: Oct. 27, 2022

(54) SPICE INJECTION-TYPE MEAT TENDERIZER

(71) Applicant: Liangdong SHAO, Yuyao City (CN)

(72) Inventor: Liangdong SHAO, Yuyao City (CN)

(21) Appl. No.: 17/238,819

(22) Filed: Apr. 23, 2021

(51) Int. Cl. A22C 9/00; A23B 4/28

(52) U.S. Cl. CPC A22C 9/001; A23B 4/28; A23V 2002/00

(57) ABSTRACT

The present disclosure provides a spice injection-type meat tenderizer including a spice storage chamber, a tenderizer injection assembly, a sleeve assembly, and a piston assembly. The tenderizer injection assembly comprises a connecting ring, a movable disc, and a baffle disc. A reset spring is disposed inside the sleeve assembly and around an outside of the spice storage chamber. Under actions of an external force and the reset spring, the sleeve assembly, the movable disc, and the spice storage chamber reciprocate between the connecting ring and the baffle disc. The piston assembly includes a piston, a baffle rod, and a stroke pipe. The stroke pipe is disposed in the spice storage chamber, and a liquid flowing outlet is opened at a top of the stroke pipe. The piston is slidably connected to an inner wall of the stroke pipe. The baffle rod runs through the movable disc and is inserted into the piston. When no external force is applied, a bottom of the piston is positioned on the movable disc, and a buffer distance is remained between a top of the baffle rod and a top of the piston. The meat tenderizer according to the present disclosure is capable of injecting flavor and tenderizing meat simultaneously. The tenderizer has merits such as convenience of use, ease of operations, safety and good controllability, ease of dismantling and cleaning, and the like.

### TECHNICAL FIELD

The present disclosure relates to the technical field of food manufacturing, and in particular, relates to a spice injection-type meat tenderizer.

### BACKGROUND

Meat food materials are indispensable in human diets in their daily lives since these materials contain rich proteins and the like nutrients. Muscle fibers of meat, especially muscle fibers of red meat such as beef are coarse and hard, such that flavor may not permeate into the meat during cooking and the meat is hard to be cooked to tenderization. To solve this problem, users are starting to treat the meat with a tenderizer. The tenderizer is a device with a blade in the front end thereof. By means of the blade, the tenderizer pierces into the meat, and cuts off the fibers, such that during curing the meat product, flavor may better permeate into the meat product, and the meat product is easily cooked. The tenderizer available in the market has only the function of cutting off fibers, and the functionality is single. If the flavor injection function is implemented by the tenderizer, tenderization and flavor injection are practiced at one time, the functionality of the product is diversified, and the operation is labor-saving and time-saving.

Some tenderizers integrating tenderization and flavor injection are also currently available in the market. However, these tenderizers has the following problems: 1. A tenderizer unit and an injection unit are driven by different driving forces, and thus the tenderizer unit and the injection unit need to be separately operated during use. As such, the use of the tenderizer is inconvenient. 2. The injection unit injects spices by means of a needle cartridge and no start restriction is configured. If a push rod is pressed before the flavor injection need does not pierce into the food material, the spices are only injected onto the surface of the food material and fail to permeate into the inside of the food material. 3. No safety lock is configured, and thus use of the tenderizer is not safe. Especially in families with children, the tenderizer has latent risks in terms of safety. Due to the above problems, the tenderizers additionally integrating the flavor injection function are not welcome among users. Therefore, for promotion and popularity of the tenderizers integrating tenderization and flavor injection, it is necessary to develop such a tenderizer that is convenient in use, simple in operation and safe for users.

### SUMMARY

The present disclosure is intended to solve one of the above problems in the related art at least to some extent. In view of this, the present disclosure provides a spice injection-type meat tenderizer, such that flavor injection and meat tenderization may be achieved at the same time. The tenderizer according to the present disclosure has merits such as convenience of use, ease of operations, safety and good controllability, ease of dismantling and cleaning, and the like.

The present disclosure employs the following technical solution: A spice injection-type meat tenderizer includes a spice storage chamber, a tenderizer injection assembly, a sleeve assembly, and a piston assembly. The tenderizer injection assembly successively includes, from top to bottom, a connecting ring, a movable disc with a knife needle and a flavor injection needle, and a baffle disc for passage of the knife needle and the flavor injection needle. The connecting ring and the movable disc are positioned in the sleeve assembly, and the connecting ring is movably connected to the sleeve assembly. The spice storage chamber is positioned on the movable disc. A reset spring is disposed inside the sleeve assembly and around an outside of the spice storage chamber. Under actions of an external force and the reset spring, the sleeve assembly, the movable disc, and the spice storage chamber reciprocate between the connecting ring and the baffle disc. A liquid flow outlet in communication with the flavor injection needle is opened at a bottom of the spice storage chamber, and a sealing cover is detachably connected to a top of the spice storage chamber. The piston assembly includes a piston, a baffle rod, and a stroke pipe. The stroke pipe is disposed in the spice storage chamber, and a liquid flowing outlet is opened at a top of the stroke pipe. The piston is slidably connected to an inner wall of the stroke pipe. One end of the baffle rod is fixed to the baffle disc, and the other end of the baffle rod runs through the movable disc and is inserted into the piston. When no external force is applied, a bottom of the piston is positioned on the movable disc, and a buffer distance is remained between a top of the baffle rod and a top of the piston.

With the above technical solution, during use, spices are first injected into the spice storage chamber, and then the sealing cover is covered thereon. The spice storage chamber or the sleeve assembly are held by hands and a downward force is applied, such that the movable disc is moved downward. In this way, the knife needle and the flavor injection needle pierce into the meat. Since a buffer distance is maintained between the piston and the baffle rod, during downward movement, the piston is not in contact with the baffle rod at the beginning until the piston moves downward with the movable disc to touch the top of the baffle rod. In this case, the piston stop moving downward. However, the movable disc and the stroke pipe may continue moving downward, and the upper space of the piston and the stroke pipe is gradually narrowed, such that the space in the spice storage chamber becomes smaller and thus the pressure is increased. In this way, the spices are extruded from the liquid flowing outlet into the flavor injection needle, and the flavor injection needle injects the spices into the food material. After the external force is canceled, under the effect of the reset spring, the sleeve assembly, the movable disc, and the spice storage chamber are all restored, and the stroke pipe is also restored with the spice storage chamber, such that the upper space of the piston and the stroke is gradually increased, and the space in the spice storage chamber is increased and thus the pressure is decreased. In this way, the spices are no longer extruded into the flavor injection needle.

Preferably, the piston includes a hollow piston body and a bottom cover with an insertion hole, wherein the bottom cover is threadedly connected to the piston body; a fixing cap is threadedly connected to the top of the baffle rod, wherein a radius of the insertion hole is less than a radius of the fixing cap; and an annular groove is opened on the piston body, wherein a sealing ring a is sleeved in the annular groove. By this design, the piston and the baffle rod are detachably connected, and are convenient in cleaning. The sealing ring a improves sealability between the piston and the stroke pipe, and prevents spices from flowing to a lower portion of the piston by the stroke pipe.

Preferably, a buffer distance maintained between the top of the piston and the top of the baffle rod is 5 mm.

Preferably, the sleeve assembly includes a sleeve body, and a connector disposed around an outside of the sleeve body; wherein a ridge is disposed inside the sleeve body, and a groove corresponding to the ridge is disposed on the connecting ring, wherein the groove forms a clearance fit with the ridge. By this design, the sleeve assembly and the connecting ring are detachably connected.

Preferably, the connector includes a lower connector, a middle connector, and an upper connector; wherein the lower connector is configured to fix the movable disc, the upper connector is configured to fix the spice storage chamber, and the middle connector, the sleeve body, and the connecting ring cooperatively constitute a safety lock assembly.

Preferably, a locking bar is disposed inside the middle connector, a side slide path is opened at a position, corresponding to the locking bar, of the sleeve body, wherein the side slide path is in an L-shaped structure, and a baffle flap and a passage that are adjacent to each other are disposed at a position, corresponding to a lateral direction of the side slide path, of the connecting ring; wherein the locking bar and the passage cooperatively constitute an unlocking unit of the safety lock assembly, and the locking bar and the baffle flap cooperatively constitute a locking unit of the safety lock assembly. The safety lock assembly enhances safety during use of the meat tenderizer according to the present disclosure, and prevents injuries during improper use of the meat tenderizer.

Preferably, the meat tenderizer assembly further includes a guide rod, wherein one end of the guide rod is fixed to the baffle disc, the other end of the guide rod is thread-fixed to the connecting ring; a slot for passage of the knife needle is opened at a position, corresponding to the knife needle, of the baffle disc; and an opening for passage of the flavor injection needle is opened at a position, corresponding to the flavor injection needle, of the baffle disc.

Preferably, the movable disc includes a knife holder disc and a cover disc; wherein the knife holder disc is provided with a snap slot of the knife needle and a latch of the flavor injection needle, the cover disc is covered on the knife holder disc and detachably connected to the knife holder disc, the spice storage chamber is positioned on the cover disc, and a sealing ring b is embedded in a joint between the spice storage chamber and the cover disc. By this design, the knife holder disc and the cover disc may be opened, and the knife needle and the flavor injection needle may be conveniently replaced. The sealing ring b enhances sealability between the spice storage chamber and the movable disc, and prevents spices from flowing into the movable disc.

Preferably, the stroke pipe and the spice storage chamber are detachably connected, which facilitates cleaning and replacement.

Preferably, the meat tenderizer further includes a protective cover, wherein the protective cover is detachably connected to the sleeve assembly. The projective cover projects the knife needle and the flavor injection needle, and achieves the effects of dust-proof and projection.

The present disclosure achieves the following beneficial effects:

1. The tenderizer implements the functions of tenderizing the meat and injecting flavor into the meat, and thus the functionality is diversified. In addition, tenderization and flavor injection are implemented by the same driving force, and do not need to be separately performed. In this way, operations are simplified, and use of the tenderizer is convenient.

2. A buffer distance is defined for the implementation of the flavor injection function, such that the flavor injection needle first enters the inside of the food material, and then the spices are injected into the food material, which prevents the spices from being only injected onto the surface of the food material.

3. A safety lock is additionally configured. Where the tenderizer is not used, the tenderizer is locked such that the tenderizer fails to move downward, which prevents unnecessary injuries to the users.

4. Most of the parts of the tenderizer are designed to be detachably connected, which gives convenience to subsequent cleaning and replacement of the parts.

### BRIEF DESCRIPTION OF THE DRAWINGS

FIG. 1 is a schematic structural view illustrating a spice injection-type meat tenderizer according to an embodiment of the present disclosure;

FIG. 2 is a schematic structural view illustrating a tenderizer injection assembly according to an embodiment of the present disclosure;

FIG. 3 is a schematic exploded view illustrating a sleeve assembly and a safety lock assembly according to an embodiment of the present disclosure;

FIG. 4 is a schematic view illustrating a sleeve body according to an embodiment of the present disclosure;

FIG. 5 is a schematic exploded view illustrating a piston assembly according to an embodiment of the present disclosure;

FIG. 6 is a partial sectional view illustrating assembling of the piston assembly according to an embodiment of the present disclosure; and

FIG. 7 is a schematic view illustrating a spice storage chamber including a stroke pipe according to an embodiment of the present disclosure.

Reference numerals and denotations thereof: 1—spice storage chamber, 11—liquid flowing outlet, 12—sealing cover, 2—tenderizer injection assembly, 21—connecting ring, 211—groove, 212—baffle flap, 213—passage, 22—movable disc, 221—knife holder disc, 222—cover disc, 23—baffle disc, 231—slot, 232—opening, 24—knife needle, 25—flavor injection needle, 26—guide rod, 3—sleeve assembly, 31—sleeve body, 311—ridge, 312—side slide path, 32—lower connector, 33—middle connector, 331—locking bar, 34—upper connector, 4—piston assembly, 41—piston, 411—piston body, 412—bottom cover, 42—baffle rod, 421—fixing cap, 43—stroke pipe, 431—liquid flow opening, 5—reset spring, 6—protective cover, a—sealing ring, and b—sealing ring.

### DETAILED DESCRIPTION

The embodiments of the present disclosure are described in detail hereinafter. Examples of the described embodiments are given in the accompanying drawings, wherein the identical or similar reference numerals constantly denote the identical or similar elements or elements having the identical or similar functions. The specific embodiments described with reference to the attached drawings are all exemplary, and are intended to illustrate and interpret the present disclosure, which shall not be construed as causing limitations to the present disclosure.

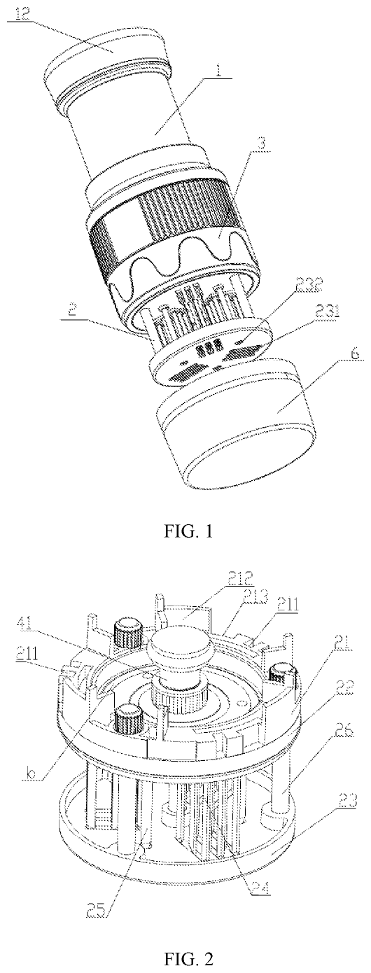

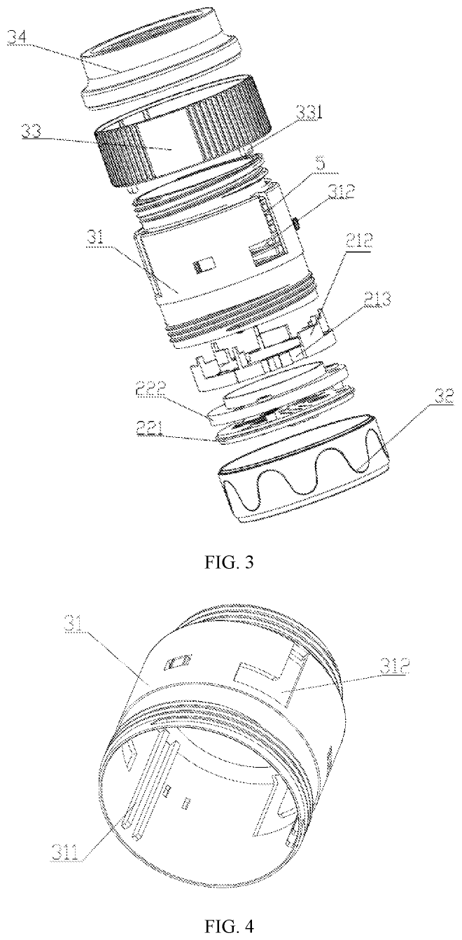

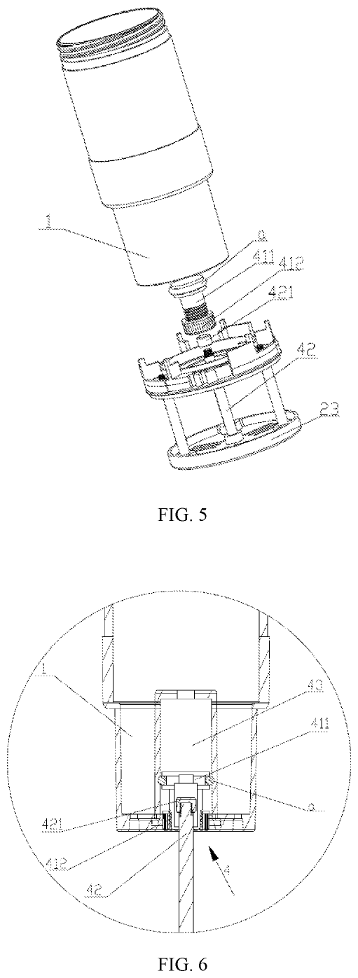

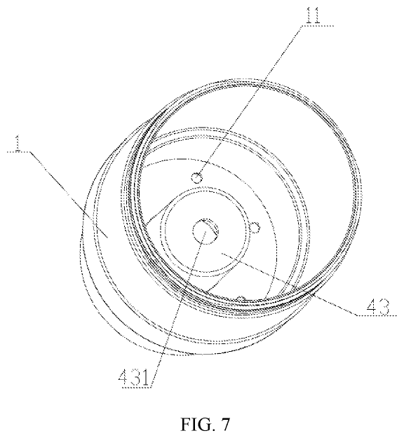

As illustrated in FIG. 1 to FIG. 7, a spice injection-type meat tenderizer includes a spice storage chamber 1, a meat tenderizer assembly 2, a sleeve assembly 3, and a piston assembly 4. The meat tenderizer is formed by parts that are detachably connected, and such design facilitates cleaning of the tenderizer and facilitates repair and replacement of the parts.

The tenderizer injection assembly 2 successively includes, from top to bottom, a connecting ring 21, a movable disc 22 with a knife needle 24 and a flavor injection needle 25, and a baffle disc 23 for passage of the knife needle 24 and the flavor injection needle 25.

The movable disc 22 includes a knife holder disc 221 and a cover disc 222. The knife holder disc 221 is provided with a snap slot of the knife needle and a latch of the flavor injection needle. The cover disc 222 is covered on the knife holder disc. The knife holder disc 221 runs through and is connected to the cover disc by a post. The knife holder disc 221 and the cover disc 222 may also be detachably connected in other fashions, such that replacement of the knife needle 24 and the flavor injection needle 25 is facilitated. Upper portions of three knife needles are connected to form a blade. The blade is snapped into the slot of the knife needle. An upper portion of the flavor injection needle 25 is in a funnel shape, and mates with a shape of the latch of the flavor injection needle. A lower portion of the flavor injection needle is provided with a flavor injection inlet for injecting spices into food materials. A through hole is opened at a position, corresponding to the latch of the flavor injection needle, of the cover disc 222. The through hole is configured to communicate the spice storage chamber 1 with the flavor injection needle 25. A sealing ring is disposed around the latch of flavor injection needle, which enhances sealability of connection between the knife holder disc and the cover disc, and prevents leakage of spices.

A slot 231 for passage of the knife needle is opened at a position, corresponding to the knife needle 24, of the baffle disc 23. An opening 232 for passage of the flavor injection needle is opened at a position, corresponding to the flavor injection needle 25, of the baffle disc 23. Before use, tips of the knife needle and the flavor injection needle are within the baffle disc 23, which prevents the tips from causing injuries to users. During use, the knife needle and the flavor injection needle respectively pierce into the food material by the slot 231 and the opening 232, and use thereof is not affected.

The tenderizer injection assembly 2 further includes a guide rod 26. One end of the guide rod 26 is fixed to the baffle disc 23, and the other end of the guide rod 26 runs through the movable disc 22 and is fixed to the connecting ring 21 by thread connection. Therefore, the baffle disc 23 and the connecting ring 21 may be fixed or secured by the guide rod, whereas the movable disc 22 is capable of moving between the baffle disc 23 and the connecting ring 21 along the guide rod 26. If the assembly needs to be disassembled, the tenderizer injection assembly 2 may be disassembled as long as the thread connection between the guide rod 26 and the connecting ring 21 is released.

The connecting ring 21 and the movable disc 22 are positioned in the sleeve assembly 3, and the connecting ring 21 is movably connected to the sleeve assembly 3. The spice storage chamber 1 is positioned on the movable disc 22. A reset spring 5 is disposed inside the sleeve assembly and around an outside of the spice storage chamber. Under actions of an external force and the reset spring 5, the sleeve assembly 3, the movable disc 22, and the spice storage chamber 1 reciprocate between the connecting ring 21 and the baffle disc 23. A liquid flow outlet 11 in communication with the flavor injection needle 25 is opened at a bottom of the spice storage chamber 1, and a sealing cover 12 is detachably connected to a top of the spice storage chamber 1. The piston assembly 4 includes a piston 41, a baffle rod 42, and a stroke pipe 43. The stroke pipe 43 is disposed in the spice storage chamber 1, and a liquid flowing outlet 431 is opened at a top of the stroke pipe 43. The piston 41 is slidably connected to an inner wall of the stroke pipe. One end of the baffle rod 42 is fixed to the baffle disc 23, and the other end of the baffle rod 42 runs through the movable disc 22 and is inserted into the piston. When no external force is applied, a bottom of the piston is positioned on the movable disc 22, and a buffer distance is remained between a top of the baffle rod 42 and a top of the piston 41. Preferably, a buffer distance maintained between the top of the piston 41 and the top of the baffle rod 42 is 5 mm.

With the above technical solution, during use, spices are first injected into the spice storage chamber 1, and then the sealing cover 12 is covered thereon. The spice storage chamber 1 or the sleeve assembly 3 is held by hands and a downward force is applied, such that the movable disc 22 is moved downward. In this way, the knife needle 24 and the flavor injection needle 25 pierce into the meat. Since a buffer distance is maintained between the piston 41 and the baffle rod 42, during downward movement, the piston is not in contact with the baffle rod 42 at the beginning until the piston 41 moves downward with the movable disc 22 to touch the top of the baffle rod 42. In this case, the piston stop moving downward. However, the movable disc 22 and the stroke pipe 43 may continue moving downward, and the upper space of the piston and the stroke pipe 43 is gradually narrowed, such that the space in the spice storage chamber becomes smaller and thus the pressure is increased. In this way, the spices are extruded from the liquid flowing outlet 11 into the flavor injection needle 25, and are injected into the food material. After the external force is canceled, under the effect of the reset spring 5, the sleeve assembly 3, the movable disc 22, and the spice storage chamber 1 are all restored, and the stroke pipe 43 is also restored with the spice storage chamber 1, such that the upper space of the piston and the stroke 43 is gradually increased, and the space in the spice storage chamber 1 is increased and thus the pressure is decreased. In this way, the spices are no longer extruded into the flavor injection needle 25.

The piston 41 includes a hollow piston body 411 and a bottom cover 412 with an insertion hole, wherein the bottom cover 412 is threadedly connected to the piston body 411. A fixing cap 421 is threadedly connected to the top of the baffle rod 42, wherein a radius of the insertion hole is less than a radius of the fixing cap 421. During assembling, the bottom cover 412 is inserted into the top of the baffle rod 42 by the insertion hole, then the fixing cap 421 at the top of the baffle rod 42 is screwed on, and finally, the piston body 411 is threadedly connected to the bottom cover 412. The tenderizer may be disassembled by performing reverse operations. The piston body 411 is provided with an annular groove. A sealing ring a is sleeved in the annular groove. The sealing ring a improves sealability between the piston 41 and the stroke pipe 43, and prevents spices from flowing to a lower portion of the piston by the stroke pipe 43.

The sleeve assembly 3 includes a sleeve body 31, and a connector disposed around an outside of the sleeve body. A ridge 311 is disposed inside the sleeve body 31, and a groove 211 corresponding to the ridge is disposed on the connecting ring 21. The groove 211 forms a clearance fit with the ridge 311, such that the sleeve assembly and the connecting ring are movably connected. When the sleeve assembly 3 reciprocates, the ridge 311 is moved upwards and downwards along the groove 211, and the connecting ring 21 does not move with the sleeve assembly 3.

The connector includes a lower connector 32, a middle connector 33, and an upper connector 34. The lower connector 32 is configured to fix the movable disc 22, the upper connector 34 is configured to fix the spice storage chamber 1, and the middle connector 33, the sleeve body 31, and the connecting ring 21 cooperatively constitute a safety lock assembly.

Preferably, a locking bar 331 is disposed in the connector 33. A side slide path 312 is opened at a position, corresponding to the blocking bar 331, of the sleeve body 31. The side slide path is in an L-shaped structure. The locking bar 331 is capable of leftward and rightward rotating in a lateral direction along the side slide path. A baffle flap 212 and a passage 213 that are adjacent to each other are disposed at a position, corresponding to the lateral direction of the side slide path, of the connecting ring 21. When the locking bar 331 rotates to be above the passage 213, the sleeve assembly 3 suffers from no hindering force and is capable of reciprocating; and thus, the locking bar 331 and the passage 213 cooperatively constitute an unlocking unit of the safety lock assembly. When the locking bar 331 rotates to be above the baffle flap 212, the sleeve assembly 3 suffers from a hindering force from the baffle flap 212 and is incapable of reciprocating; and thus, the locking bar 331 and the baffle flap 212 cooperatively constitute a locking unit of the safety locking assembly. The safety locking assembly enhances safety during use of the meat tenderizer according to the present disclosure, and prevents injuries during improper use of the meat tenderizer. An anti-slide strip is further disposed on an outer side of the middle connector, which facilitates rotation.

Preferably, the spice storage chamber 1 is positioned on the cover disc 222 of the movable disc 22, and a sealing ring b is embedded in a joint between the cover disc and the spice storage chamber 1. The number of sealing rings b may be increased according to the actual needs. The sealing ring b enhances sealability between the spice storage chamber 1 and the movable disc 22, and prevents spices from flowing into the movable disc 22.

The stroke pipe 43 and the spice storage chamber 1 may be designed as an integral body, or may be designed to be detachably connected. The length of the stroke pipe may be defined according to the actual stroke of the piston, preferably 25 to 40 mm.

This embodiment further includes a protective cover 6. The protective cover 6 covers therein the baffle disc 23, the knife needle 24, and the flavor injection needle 25, and a top of the protective cover 6 is detachably connected to the sleeve assembly 3. The projective cover projects the knife needle 24 and the flavor injection needle 25, and achieves the effects of dust-proof and projection.

Although the present application is described in detail with reference to these embodiments, a person skilled in the art may also make various modifications to the technical solutions disclosed in the embodiments, or make equivalent replacements to a part of the technical features contained therein. Such modifications or replacement, made without departing from the principles of the present disclosure, shall fall within the scope of the present disclosure.

1. A spice injection-type meat tenderizer, comprising a spice storage chamber (1) and a tenderizer injection assembly (2); wherein the tenderizer further comprises:
a sleeve assembly (3) and a piston assembly (4); wherein the tenderizer injection assembly (2) successively comprises, from top to bottom, a connecting ring (21), a movable disc (22) with a knife needle (24) and a flavor injection needle (25), and a baffle disc (23) for passage of the knife needle and the flavor injection needle; wherein the connecting ring (21) and the movable disc (22) are positioned in the sleeve assembly (3), and the connecting ring (21) is movably connected to the sleeve assembly (3); the spice storage chamber (1) is positioned on the movable disc (22); a reset spring (5) is disposed inside the sleeve assembly and around an outside of the spice storage chamber; under actions of an external force and the reset spring (5), the sleeve assembly (3), the movable disc (22), and the spice storage chamber (1) reciprocate between the connecting ring (21) and the baffle disc (23);
a liquid flow outlet (11) in communication with the flavor injection needle (25) is opened at a bottom of the spice storage chamber (1), and a sealing cover (12) is detachably connected to a top of the spice storage chamber; and
the piston assembly comprises a piston (41), a baffle rod (42), and a stroke pipe (43); wherein the stroke pipe (43) is disposed in the spice storage chamber, and a liquid flow opening (431) is opened at a top of the stroke pipe; the piston (41) is slidably connected to an inner wall of the stroke pipe; one end of the baffle rod (42) is fixed to the baffle disc (23), and the other end of the baffle rod (42) runs through the movable disc (22) and is inserted in an inner portion of the piston; and when no external force is applied, a bottom of the piston is positioned on the movable disc, and a buffer distance is remained between a top of the baffle rod (42) and a top of the piston (41).

2. The spice injection-type meat tenderizer according to claim 1, wherein
the piston (41) comprises a hollow piston body (411) and a bottom cover (412) with an insertion hole, the bottom cover being threadedly connected to the piston body; a fixing cap (421) is threadedly connected to the top of the baffle rod (42), a radius of the insertion hole being less than a radius of the fixing cap; and an annular groove is opened on the piston body, a sealing ring a being sleeved in the annular groove.

3. The spice injection-type meat tenderizer according to claim 1, wherein
a buffer distance maintained between the top of the piston and the top of the baffle rod is 5 mm.

4. The spice injection-type meat tenderizer according to claim 1, wherein
the sleeve assembly (3) comprises a sleeve body (31), and a connector disposed around an outside of the sleeve body; wherein a ridge (311) is disposed inside the sleeve body (31), and a groove (211) corresponding to the ridge is disposed on the connecting ring, the groove (211) forming a clearance fit with the ridge (311).

5. The spice injection-type meat tenderizer according to claim 4, wherein
the connector comprises a lower connector (32), a middle connector (33), and an upper connector (34); wherein the lower connector (32) is configured to fix the movable disc (22), the upper connector (34) is configured to fix the spice storage chamber (1), and the middle connector (33), the sleeve body (31), and the connecting ring (21) cooperatively constitute a safety lock assembly.

6. The spice injection-type meat tenderizer according to claim 5, wherein
a locking bar (331) is disposed inside the middle connector (33), a side slide path (312) is opened at a position, corresponding to the locking bar, of the sleeve body (31), the side slide path being in an L-shaped structure, and a baffle flap (212) and a passage (213) that are adjacent to each other are disposed at a position, corresponding to a lateral direction of the side slide path, of the connecting ring; wherein the locking bar (331) and the passage (213) cooperatively constitute an unlocking unit of the safety lock assembly, and the locking bar (331) and the baffle flap (212) cooperatively constitute a locking unit of the safety lock assembly.

7. The spice injection-type meat tenderizer according to claim 1, wherein
the meat tenderizer assembly further comprises a guide rod (26), one end of the guide rod (26) being fixed to the baffle disc (23), the other end of the guide rod (26) being thread-fixed to the connecting ring (21); a slot (231) for passage of the knife needle is opened at a position, corresponding to the knife needle, of the baffle disc (23); and an opening (232) for passage of the flavor injection needle is opened at a position, corresponding to the flavor injection needle, of the baffle disc.

8. The spice injection-type meat tenderizer according to claim 1, wherein
the movable disc comprises a knife holder disc (221) and a cover disc (222); wherein the knife holder disc is provided with a snap slot of the knife needle and a latch of the flavor injection needle, the cover disc (222) is covered on the knife holder disc and detachably connected to the knife holder disc, the spice storage chamber is positioned on the cover disc, and a sealing ring b is embedded in a joint between the spice storage chamber and the cover disc.

9. The spice injection-type meat tenderizer according to claim 1, wherein
the stroke pipe (43) is detachably connected to the spice storage chamber (1).

10. The spice injection-type meat tenderizer according to claim 1, further comprising:
a protective cover (6), wherein the protective cover (6) is detachably connected to the sleeve assembly (3).
